(19) United States
(12) Patent Application Publication
(10) Pub. No.: US 2020/0228259 A1
(43) Pub. Date: Jul. 16, 2020

(54) METHOD AND USER DEVICE FOR TRANSMITTING HARQ ACK/NACK INFORMATION

(71) Applicant: LG ELECTRONICS INC., Seoul (KR)

(72) Inventors: Seunggye HWANG, Seoul (KR); Bonghoe KIM, Seoul (KR); Suckchel YANG, Seoul (KR); Joonkui AHN, Seoul (KR); Changhwan PARK, Seoul (KR); Seonwook KIM, Seoul (KR)

(21) Appl. No.: 16/629,516

(22) PCT Filed: Jul. 11, 2018
(86) PCT No.: PCT/KR2018/007858

§ 371 Date: Jan. 8, 2020

Related U.S. Application Data
(60) Provisional application No. 62/531,360, filed on Jul. 12, 2017.

(51) Int. Cl. H04L 1/18; H04L 5/00; H04W 72/12

(52) U.S. Cl. CPC H04L 1/1861; H04L 5/0007; H04W 72/1273; H04W 72/1289; H04L 5/0055

(57) ABSTRACT

The disclosure of the present specification provides a method for transmitting, by a user device, hybrid automatic repeat request (HARQ) positive-acknowledgment (ACK)/negative-acknowledgment (NACK) information. The method may comprise the steps of: determining a channel coding scheme to be used for transmitting the HARQ ACK/NACK information through an uplink physical channel, on the basis of first information; and performing channel coding of the HARQ ACK/NACK information according to the determined channel coding scheme. The channel coding scheme may include at least one of a channel coding scheme, a cyclic redundancy check (CRC) architecture, a channel encoder size, and a modulation scheme.

### BACKGROUND

### Field of the Disclosure

The present disclosure relates to mobile communication.

### Related Art

Thanks to the success of the Long Term Evolution (LTE)/LTE-Advanced (LTE-A) for the 4-th mobile communication, the next-generation, namely, the fifth (so-called 5G) mobile communication is getting more attention, and more and more researches on that subject are being carried out.

It is expected that in the next generation mobile communication, namely the 5-th mobile communication, data services with a minimum speed of 1 Gbps will be realized.

In 5G mobile communication, a turbo code, a polar code, a low density parity check (LDPC) code, etc. are considered as a channel coding scheme.

Meanwhile, in the 5G mobile communication, a more effective method for enabling a user device to transmit a hybrid automatic repeat request (HARQ) positive-acknowledgement (ACK)/negative-acknowledgement (NAC).

### SUMMARY OF THE DISCLOSURE

Accordingly, a disclosure of the present specification has been made in an effort to solve the aforementioned problem.

According to an aspect of the present disclosure, there is provided a method performed by a user equipment (UE) to transmit hybrid automatic repeat request (HARQ) positive-acknowledgement (ACK)/negative-acknowledgement (NACK) information, the method including determining, based on first information, a channel coding scheme to be used to transmit the HARQ ACK/NACK information through an uplink physical channel, and performing channel coding on the HARQ ACK/NACK information according to the determined channel coding scheme. The channel coding scheme may include at least one of a channel coding scheme, a cyclical redundancy check (CRC) architecture, a channel encoder size, and a modulation scheme.

The method may further include receiving downlink control information (DCI) through a downlink control channel, and receiving, based on the DCI, downlink data through a downlink data channel. The HARQ ACK/NACK information may be associated with the downlink data.

The first information may include a payload size of the HARQ ACK/NACK information.

When total downlink assignment index (DAI) is included in the DCI, the payload size of the HARQ ACK/NACK information may be determined on the basis of the total DAI.

When only counter DAI except total DAI is included in the DCI, the payload size of the HARQ ACK/NACK information may be determined on the basis of a fixed value.

When only counter DAI except total DAI is included in the DCI, the payload size of the HARQ ACK/NACK information may be determined on the basis of a maximum value of a detected counter DAI.

The maximum value of the detected counter DAI is Lcounter, the payload size of the HARQ ACK/NACK information may be determined on the basis of a smallest values among values greater than Lcounter+x in a candidate set Z={L1, L2, . . . , LM}.

The CRC structure may include a CRC length, a distributed CRC type, a multiple CRC type, and a parity check bit.

According to another aspect of the present disclosure, there is provided a user equipment (UE) for transmitting hybrid automatic repeat request (HARQ) positive-acknowledgement (ACK)/negative-acknowledgement (NACK) information, the UE including a transceiver and a processor configured to control the transceiver. The processor may be further configured to determine, based on first information, a channel coding scheme to be used to transmit the HARQ ACK/NACK information through an uplink physical channel, and perform channel coding on the HARQ ACK/NACK information according to the determined channel coding scheme. The channel coding scheme may include at least one of a channel coding scheme, a cyclical redundancy check (CRC) architecture, a channel encoder size, and a modulation scheme.

According to the disclosure of the present disclosure, the problem of the conventional technology described above may be solved.

### BRIEF DESCRIPTION OF THE DRAWINGS

FIG. 1 is a wireless communication system.

FIG. 2 illustrates a structure of a radio frame according to FDD in 3GPP LTE.

FIG. 3 illustrates an example of a procedure of processing data transmission.

FIG. 4 illustrates an example of a subframe type in NR.

FIG. 4a illustrates a basic concept of a polar code, and FIG. 4b illustrates a structure of an SC decoder.

FIG. 6 is a diagram schematically illustrating a method according to a disclosure of the present specification.

FIGS. 7A and 7B are diagram illustrating examples of a correlation between each distributed CRC block and each distributed data block when a distributed CRC structure is applied.

FIG. 8 is a block diagram of a wireless communication system implementing a disclosure of the present specification.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present disclosure will be applied. This is just an example, and the present disclosure may be applied to various wireless communication systems. Hereinafter, LTE includes LTE and/or LTE-A.

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present disclosure includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present disclosure, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

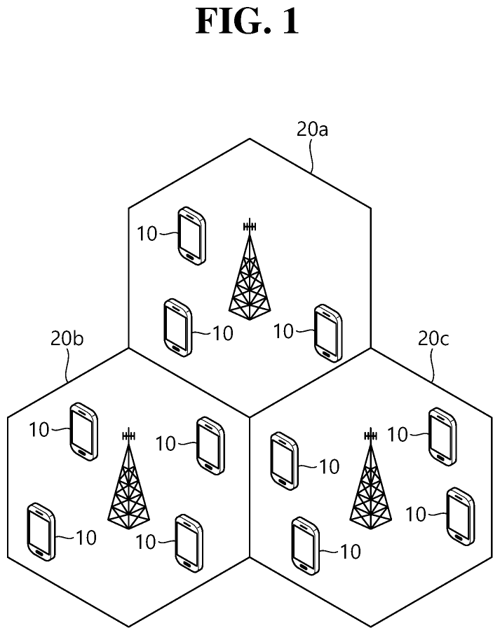

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c. The cell can be further divided into a plurality of areas (sectors).

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE1 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

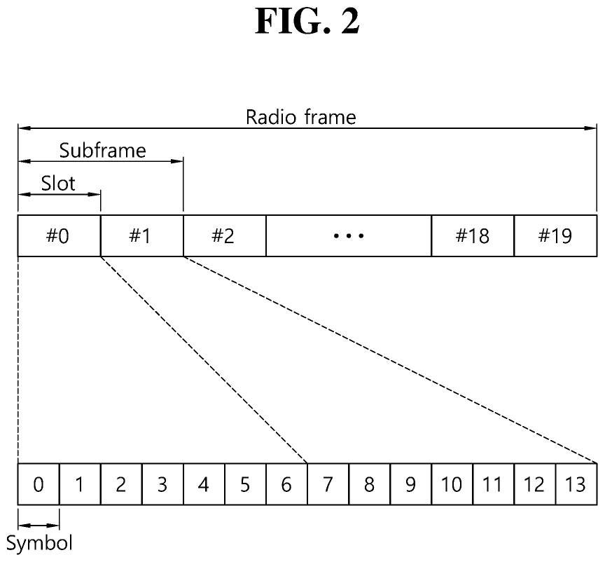

FIG. 2 shows a downlink radio frame structure according to FDD of 3rd generation partnership project (3GPP) long term evolution (LTE).

The radio frame includes 10 sub-frames indexed 0 to 9. One sub-frame includes two consecutive slots. Accordingly, the radio frame includes 20 slots. The time taken for one sub-frame to be transmitted is denoted TTI (transmission time interval). For example, the length of one sub-frame may be 1 ms, and the length of one slot may be 0.5 ms.

The structure of the radio frame is for exemplary purposes only, and thus the number of sub-frames included in the radio frame or the number of slots included in the sub-frame may change variously.

Meanwhile, one slot may include a plurality of OFDM symbols. The number of OFDM symbols included in one slot may vary depending on a cyclic prefix (CP).

One slot includes NRB resource blocks (RBs) in the frequency domain. For example, in the LTE system, the number of resource blocks (RBs), i.e., NRB, may be one from 6 to 110.

The resource block is a unit of resource allocation and includes a plurality of sub-carriers in the frequency domain. For example, if one slot includes seven OFDM symbols in the time domain and the resource block includes 12 sub-carriers in the frequency domain, one resource block may include 7×12 resource elements (REs).

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The uplink channels include a PUSCH, a PUCCH, an SRS (Sounding Reference Signal), and a PRACH (physical random access channel).

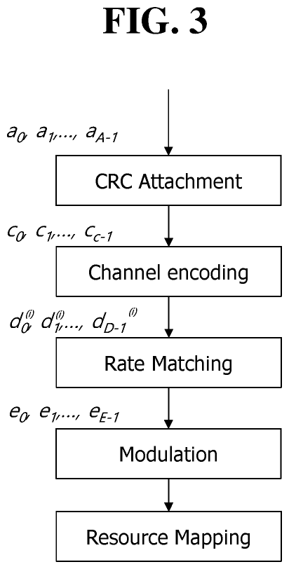

FIG. 3 illustrates an example of a procedure of processing data transmission.

Data bits (that is, a0, a1, . . . , aA−1) are transmitted in the form of a single transport block at every TTI from a Medium Access Control (MAC) layer. A physical layer generates bits c0, c1, . . . , cC−1 by adding cyclic redundancy check (CRC) to the information bits (that is, a0, a1, . . . , aA−1).

Channel encoding is performed on the generated bits. For example, a Tail-biting Convolutional Code (TBCC) with an encoding rate of ⅓ may be used for the channel encoding. The encoded sequences may be represented as d(i)0, d(i)1, . . . , d(i)(D−1), where d denotes the number of encoded bits per output stream and I denotes an index of an output bit stream. Rate matching may be performed on the encoded sequences, thereby outputting e0, e1, . . . , eA−1.

After the rate matching is performed, demodulation is performed. Demodulated symbols may be mapped to physical resource elements (Res) and then transmitted.

<The Next-Generation Mobile Communication Network>

Thanks to the success of the Long Term Evolution (LTE)/LTE-Advanced (LTE-A) for the 4-th mobile communication, the next-generation, namely, the fifth (so-called 5G) mobile communication is getting more attention, and more and more researches on that subject are being carried out.

The fifth-generation mobile communication as defined by the International Telecommunication Union (ITU) intends to provide a data transfer speed of up to 20 Gbps and an effective transfer speed of at least 100 Mbps or more at any location. The official name of the fifth-generation mobile communication is ‘IMT-2020’, of which global commercialization is targeted at 2020.

The ITU published three primary use scenarios based on the fifth-generation mobile communication, including enhanced Mobile BroadBand (eMBB), massive Machine Type Communication (mMTC), and Ultra Reliable and Low Latency Communication (URLLC).

URLLS pertains to a use scenario which requires high reliability and low latency. For example, services such as automated driving, factory automation, and augmented reality require high reliability and low latency (for example, latency less than 1 ms). The latency of the current 4G (LTE) communication ranges statistically from 21 to 43 ms (best 10%) and from 33 to 75 ms (median). This performance is not sufficient for supporting services based on latency less than 1 ms. Next, eMBB-based scenarios relate to use scenarios requiring mobile ultra-broadband.

In other words, the fifth-generation mobile communication system targets higher capacity than the current 4G LTE, increases density of mobile broadband users, and supports Device-to-Device (D2D), high reliability, and Machine Type Communication (MTC). Researches on the 5G system targets lower waiting time and lower battery consumption than the 4G mobile communication system to better implement the Internet of Things. To realize the aforementioned 5G mobile communication, a new radio access technology (New RAT or NR) may be proposed.

In the NR, a downlink subframe may be considered for reception from a base station while an uplink subframe may be considered for transmission to the base station. This way of operation may be applied to paired and unpaired spectra. One pair of spectra indicates that two subcarrier spectra are involved for downlink and uplink operations. For example, in one pair of spectra, one subcarrier may include a downlink and uplink bands forming a pair with each other.

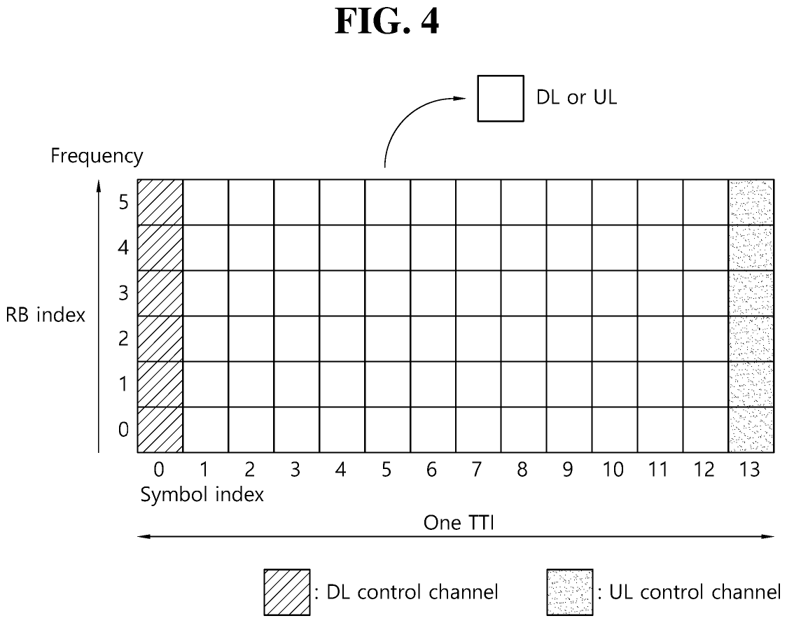

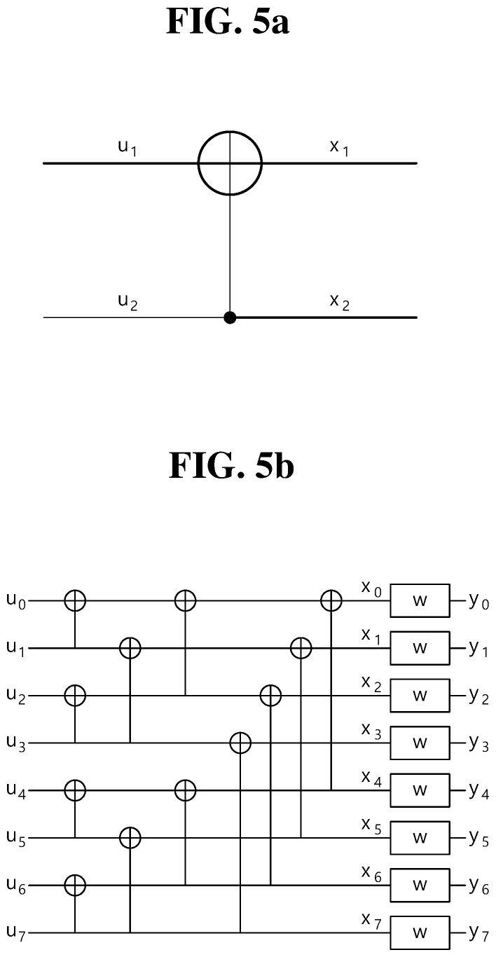

FIG. 4 illustrates an example of a subframe type in NR.

Transmission Time Interval (TTI) shown in FIG. 4 may be referred to as a subframe or slot for NR (or new RAT). The subframe (or slot) of FIG. 4 may be used in the TDD system of NR (or new RAT) to minimize data transfer latency. As shown in FIG. 4, a subframe (or slot) includes 14 symbols in the same way as a current subframe. The preceding symbols of a subframe (or symbol) may be used for a DL control channel, and the succeeding symbols of the subframe (or symbol) may be used for an UL control channel. Other symbols may be used for DL data transmission or UL data transmission. According to such a subframe (or slot) structure, downlink transmission and uplink transmission may be performed sequentially in one subframe (or slot). Therefore, downlink data may be received within a subframe (or slot), or an uplink acknowledgement response (ACK/NACK) may be transmitted within the subframe (or slot). Such a subframe (or slot) structure may be called a self-contained subframe (or slot). When such a subframe (or slot) structure is used, an advantage may be obtained that time taken for retransmitting erroneously received data is reduced, and thereby final data transmission waiting time is minimized. In the self-contained subframe (or slot) as described above, a time gap may be required to secure a transition process to and from a transmission and a reception mode. To this purpose, when the subframe structure transitions from DL to UL mode, part of OFDM symbols may be configured as Guard Periods (GPs).

Requirements on the 5G system include latency, peak data rate, and error correction. The 5G system expected to be used not only for mobile communication services but also for ultra-high resolution media streaming, Internet of Things, cloud computing, and self-driving vehicles targets much higher performance than the system requirements of the LTE system in many areas.

The 5G system targets 1 ms of latency, which is 1/10 of the LTE latency. This short latency is an important indicator in such a service area directly related to human life, like self-driving vehicles. The 5G system also targets a high transmission rate. The maximum transfer rate of the 5G system is targeted to be 20 times that of the LTE, and the effective transfer rate 10 to 100 times that of the LTE, by which high capacity ultra-high speed communication such as a high quality media streaming service may be sufficiently supported. Error-correction capability reduces data re-transmission rate and eventually improves latency and data transfer rate.

Turbo codes, polar codes, and LDPC codes are considered first as a 5G channel coding scheme.

First, turbo codes concatenate convolution codes in parallel, which apply different arrays of the same sequence to two or more component encoders. For a decoding method, turbo codes use a soft output iterative decoding method. Since the basic principle of turbo code decoding is to improve decoding performance by exchanging information about each bit within a decoding period and using the exchanged information for the next decoding, it is necessary to obtain soft output during a decoding process for turbo codes. This stochastic iterative decoding scheme leads to excellent performance and speed.

Next, an LDPC code relies on the characteristics of the LDPC iterative decoding scheme which improves error-correcting capability per bit by increasing the code length while retaining computational complexity per bit. Also, since codes may be designed so that computations for decoding may be performed in parallel, decoding of a long code may be processed at a high speed.

Lastly, a polar code has low encoding and decoding complexity and is the first error-correcting code which has been theoretically proven to achieve a channel capacity in a general binary input discrete memoryless symmetric channel. Differently from the LDPC and turbo code which use an iterative decoding process, the polar code uses Successive Cancellation (SC) decoding and list decoding in conjunction with each other. Also, differently from the LDPC code which improves performance by employing parallel processing, the polar code improves performance through pipelining.

FIG. 5a illustrates a basic concept of a polar code, and FIG. 5b illustrates a structure of an SC decoder.

Referring to FIG. 5a, different inputs u1, u2 go through the respective channels and are output through x1, x2 separately. At this time, suppose u2 has gone through a relatively good channel, while u1 has gone through a channel in relatively poor conditions. If the structure of FIG. 10a is repeated, u2 which goes through channels in good conditions is getting better while u1 which goes through channels in poor conditions is getting worse, which may be structured as shown in FIG. 10b. This structure is called polarization.

The structure as shown in FIG. 10b may be expressed by a Kronecker product of two 2×2 kernel matrices. Therefore, an encoder is always built in the exponential form with a base of 2.

FIG. 5b assumes that the channel through which an input u7 passes is in better conditions than the channel through which an input u0 passes. In other words, it is assumed that a large index generally indicates a channel in good conditions.

The polar code exploits such a polarization effect, which maps data to a channel in good conditions and maps frozen bits (namely bit information known in advance, such as 0) to a channel in poor conditions.

At this time, a code rate is determined by the number of data bits divided by a sum of the number of data bits and the number of frozen bits.

<Disclosure of this Specification>

In the next-generation mobile communication system, a more effective method for transmitting hybrid automatic repeat request (HARQ) positive-acknowledgement (ACK)/negative-acknowledgement (NACK) is necessary.

Accordingly, in the present specification, there is proposed a method in which a terminal in a wireless communication system indicates successful decoding of a plurality of PDSCHs by utilizing a plurality of HARQ ACK/NACK bits corresponding to the respective PDSCHs, multiplexes the plurality of HARQ ACK/NACK bits onto a single transmitting channel, transmitting the plurality of HARQ ACK/NACK bits, and applying a corresponding channel coding scheme (or a channel coding criteria).

In the present specification, the terminal may receive grants for the plurality of PDSCHs through the plurality of PDCCHs. At this point, HARQ ACK/NACK received by the terminal with respect to the plurality of PDSCHs may be multiplexed onto a single uplink channel (e.g., a PUCCH). In this case, in order to match interpretation on the HARQ-ACK between the terminal and a base station, each PDCCH may include information such as downlink assignment index (DAI). DAI considered in the present specification may be divided namely into two types. One type of the DAI is counter DAI for representing an index of each PDCCH and the other type of the DAI is total DAI for indicating a total number of PDSCHs. If the terminal monitors PDCCHs through one or more CCs or CC groups and a plurality of total DAI is given for each CC or for each CC group, the total DAI used in the following description may refer to a sum of all total DAI obtained by the terminal.

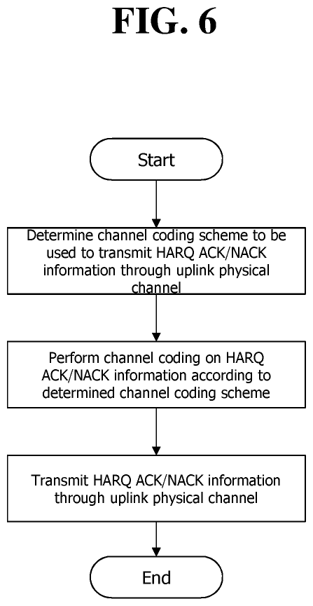

FIG. 6 is a diagram schematically illustrating a method according to a disclosure of the present specification.

Referring to FIG. 6, a user equipment (UE) may use first information to determine a channel coding criteria to be used to transmit HARQ-ACK/NACK information through an uplink physical channel. The first information may be predetermined information A which will be described below.

Then, the UE may perform channel coding on the HARQ-ACK/NACK information according to the determined channel coding criteria.

Then, the UE transmits the HARQ-ACK/NACK information through the uplink physical channel.

1. Proposal 1

According to Proposal 1, a channel coding criteria used by a terminal in an uplink physical channel used to transmit HARQ-ACK may be determined as a function of “predetermined information A.”

The predetermined information A mentioned in the Proposal 1 may be one of definitions mentioned Proposal 1-1, Proposal 1-2, or Proposal 1-3.

The channel coding criteria mentioned in the Proposal 1 may be a combination of one or more of the following A to D.

A. Channel Coding Scheme

The predetermined information mentioned in the Proposal 1 may be used to select one of channel coding schemes (e.g., a low density parity check (LDPC), Turbo code, Polar code, RM code, a repetition code, and the like).

Specifically, a channel coding scheme considered in NR may be the polar code or the RM code.

B. Cyclical Redundancy Check (CRC) Architecture

The predetermined information A mentioned in the Proposal 1 may be used to select a CRC structure.

At this point, the CRC structure may be a combination of one or more of the following.
CRC length: The predetermined information A may be used to select a CRC length.
Distributed CRC or multiple CRC: The predetermined information A may be used to select a position at which a CRC is configured. Specifically, in the case of a polar code used in a control channel of NR, positions of CRC bits may depend on a size of a payload. Specifically, this may be determined depending on a condition in which CRC bits depend on a size of a mother code. At this point, the size of the mother code may vary depending on the size of the payload.
Parity Check Bit: The predetermined information A may be used to select whether to use a parity check bit, and a position of the parity check bit. Specifically, in the case of a polar code used in a control channel of NR, the parity check bit may vary depending on a size of a payload.

C. Channel Encoder Size Selection

The predetermined information A mentioned in the Proposal 1 may be used to select a size of an encoder used in a channel coding scheme.

In the case of a polar code, the size of the encoder may be determined to be 2n, where n is any natural number.

At this point, a scheme for applying a rate matching may depend on the size of the encoder.

For example, in the case of a polar code, when a bit size M capable of being mapped to an uplink physical channel for transmission satisfies a condition of 2n<M<2n+1, repetition may be used if an encoder having a size of 2n is used, and puncturing or shorting may be used if an encoder having a size of 2n+1 is used.

D. Modulation Method

The predetermined information A mentioned in the Proposal 1 may be used to select a modulation scheme used in an uplink physical channel for transmission. At this point, a scheme for applying a rate matching may depend on modulation.

For example, in the case of a polar code, when a bit size M capable of being mapped to an uplink physical channel for transmission satisfies 2n<M<2n+1, BPSK modulation may be used in response to an encoder having a size of 2n or QPSK modulation may be used in response to an encoder having a size of 2n+1.

When a base station provides a terminal with information related to HARQ-ACK through DCI, the information may include both total DAI and counter DAI. At this point, the total DAI may allow the terminal to accurately recognize a total HARQ-ACK payload size. By using the total HARQ-ACK payload size, it is possible to determine the channel coding schemes mentioned in the Proposal 1. The following Proposal 1-1 suggests a method applicable in such a situation.

1-1. Proposal 1-1: The Predetermined Information A May be a Size of a HARQ-ACK Payload.

At this point, if total DAI and counter DAI are given through DCI, the size of the HARQ-ACK payload may be determined with reference to the total DAI.

In the Proposal 1-1, if a value of the total DAI is Ltotal, a method for determining the size of the HARQ-ACK payload may be one of the following options.

Option 1-1-a. The size of the HARQ-ACK payload may be L=Ltotal.

Option 1-1-b. The size of the HARQ-ACK payload may be determined as L=max (Ltotal, Tpayload).

At this point, Tpayload is a threshold defined to support the Proposal 1-1 and may be semi-statically determined through system information block (SIB) or a higher layer signal such as an RRC signal.

A position at which each HARQ-ACK bit is located in the HARQ-ACK payload may be determined through counter DAI included in DCI corresponding to a corresponding HARQ-ACK bit.

If the terminal is missing DCI including particular counter DAI, a HARQ-ACK bit corresponding to the missing DCI may be set to follow the expression of NACK.

In the case where a channel coding scheme is determined using the predetermined information A defined in the Proposal 1-1 and in the case where a HARQ-ACK payload in a control channel of NR is less than 12, a RM code may be used: in other cases, a polar code may be used.

Determining CRC structure using the predetermined information A defined in the Proposal 1-1.

As a specific example, if a HARQ-ACK payload in a control channel of NR is less than 12, a CRC length may be 0.

As a specific example, if a HARQ-ACK payload in a control channel of NR is less than 22 and a polar code is used as a channel coding scheme, a CRC and/or a parity check bit may be used.

As a specific example, a position of a distributed CRC may depend on a size of a HARQ-ACK payload in a control channel of NR. This may be a method for determining an interleaving pattern that is applied after CRC is attached to data.

In the case where a size of an encoder is determined using the predetermined information A defined in the Proposal 1-1 and in the case where the polar code is used in a control channel of NR, a polar code encoder size may be determined on the basis of a sum of a HARQ-ACK payload size and a CRC length.

At this point, as a criterion of determining the polar code encoder size, a threshold TE_size may be applied with respect to the sum of the HARQ-ACK payload size and the CRC length.

For example, suppose that the HARQ-ACK payload is defined as L and the CRC length is defined as LCRC. In this case, an encoder having a size of Nrep=2n may be applied if L+LCRC<TE_size is satisfied, and an encoder having a size of Npunc=2n+1 may be applied if L+LCRC≥TE_size is satisfied. It this point, a bit size M capable of being mapped to an uplink physical channel for transmission may satisfy a condition of 2n<M<2n+1.

In the case where modulation is determined using the predetermined information A defined in the Proposal 1-1, if a HARQ-ACK payload in a control channel of NR is less than a predetermined threshold LThr, BPSK (or π/2-BPSK) may be used, and, if the HARQ-ACK payload in a control channel of NR is equal to or greater than the predetermined threshold LThr, QPSK may be used.

In the Proposal 1-1, if HARQ-ACK is transmitted along with other uplink channel information (e.g., CRI report, scheduling request (SR), and the like), the above-described operations described on the basis of the HARQ-ACK payload may be set to be performed on the basis of a total sum of the HARQ-ACK payload and other uplink channel information payload.

In the case where the base station provides the terminal with information related to HARQ-ACK through DCI, the information may include only DAI, except total DAI. This may be to prevent an increase in DCI overhead caused by provision of the DAI. At this point, the terminal may not accurately recognize a total HARQ-ACK payload size intended by the base station. In this case, the terminal may determine a HARQ-ACK payload size on the basis of the counter DAI recognized by the terminal, and the base station may be set to determine the HARQ-ACK payload size intended by the terminal by using a blind decoding scheme. The following Proposal 1-2 suggests a method that is applicable in such a situation.

1-2. Proposal 1-2. The Predetermined Information A May be a HARQ-ACK Payload Size.

At this point, if only counter DAI except total DAI is give through DCI, the HARQ-ACK payload size may be determined on the basis of a maximum value of the counter DAI detected by the terminal.

In the Proposal 1-2, when the maximum value of the counter DAI detected by the terminal is Lcounter, a method for determining a HARQ-ACK payload may be one of the following options.

Option 1-2.a: The HARQ-ACK payload size may be L=Lcounter.

Option 1-2-b: The HARQ-ACK payload size may be set to be selected as the smallest value among values greater than Lcounter+x in a candidate set Z={L1, L2, . . . , LM}.

In this case, the set Z={L1, L2, . . . , LM} may be a set defined to support the Proposal 1-2, and a method for setting the aforementioned set may be one of the following options.

Option 1-2-c: It may be semi-statically determined through SIB or a higher layer signal such as an RRC signal.

Option 1-2-d: It may be a value determined according to a resource size (e.g., the number of RBs, the number of subcarriers, and/or the number of symbols) of an uplink physical channel used for transmitting HARQ-ACK by a terminal and/or according to a HARQ-ACK configuring method (e.g., a PUCCH format).

In this case, x is a value defined to support the Proposal 1-2 and equal to or greater than 0, and a method for configuring the value of x may be one of the following options. The value of x may be applied in order to prepare for the case where part of DCI is missing.

Option 1-2-e: It may be semi-statically determined through SIB or a higher layer signal such as an RRC signal.

Option 1-2-f: It may be a value determined according to a resource size (e.g., the number of RBs, the number of subcarriers, and/or the number of symbols) of an uplink physical channel used by a terminal to transmit HARQ-ACK and/or according to an HARQ-ACK configuring method (e.g., a PUCCH format).

Option 1-2-g: A HARQ-ACK payload size may be determined as L=max(Lcounter, Tpayload).

In this case, Tpayload may be a threshold defined to support the Proposal 1-2 and may be semi-statically determined through SIB or a higher layer signal such as an RRC signal.

A position at which each HARQ-ACK bit is mapped within a HARQ-ACK payload may be determined through counter DAI included in DCI corresponding to a corresponding HARQ-ACK bit.

If the terminal is missing DCI including particular DAI having an index smaller than L, a HARQ-ACK bit corresponding to the missing DCI may be set to follow the expression of NACK.

If the terminal is missing DCI including particular counter DAI having an index greater than L, especially if a polar code is used, a method for processing a HARQ-ACK bit corresponding to the missing DCI may be one of the following options.

Option 1-2-h: A corresponding HARQ-ACK bit may be processed into a frozen bit. In this case, a rule (e.g., scrambling) applied to other frozen bits may be equally applied to the corresponding bit.

This has an advantage of processing a missing bit without additional information.

Option 1-2-i: A corresponding HARQ-ACK bit may be set to follow the expression of NACK. In this case, a rule (e.g., scrambling) applied to a frozen bit is not applied to the corresponding bit.

The terminal may perform Option 1-2-i on the basis of information on the maximum number of bits to be used for a HARQ-ACK bit in an uplink physical channel through which HARQ-ACK is transmitted.

In this case, the maximum number of bits to be used for HARQ-ACK bits may be fixed on the basis of the purpose of the corresponding uplink physical channel, a target code rate, and the like. Alternatively, the maximum number of bits to be used for HARQ-ACK bits may be semi-statically designated to the terminal through SIB or a higher layer signal such as an RRC signal.

This may be to express information on a HARQ-ACK bit corresponding to missing DCI and to prevent the expression of NACK from being affected by a rule such as scrambling applied to a frozen bit.

When a channel coding scheme is determined using the predetermined information A defined in the Proposal 1-2, a criterion of determining a channel coding scheme in a control channel of NR may be, for example, one of the following options.

Option 1-2-j: If a HARQ-ACK payload is less than 12, an RM code may be used: otherwise, a polar code may be used. This may be to follow the definition of a channel coding scheme in NR, the scheme which is applied according to a payload of control data.

Option 1-2-k: It may be set such that a polar code is always used regardless of a HARQ-ACK payload. In order to support Option 1-2-k, the HARQ-ACK payload may be determined using the Option 1-2-g. The terminal may map remaining bits, except L number of HARQ-ACK bits to be transmitted, among Lmax number of HARQ ACK bits to frozen bit or NACK information. This may be to reduce decoding complexity that is likely to happen when there is a plurality of channel coding schemes to be decoded by the base station.

In the case of determining a CRC structure using the predetermined information A defined in the Proposal 1-2, a method for determining a CRC length in a control channel of NR may be one of the following options.

Option 1-2-1: When the HARQ-ACK payload is L<12, the CRC length may be 0. In this case, if the HARQ-ACK payload is L and a CRC length satisfying a FAR target is LFAR, L+LFAR<22 is satisfied, and, if a polar code is used, a total CRC length may satisfy LCRC=LFAR+3 and may include 3-bit parity bits. If L+LFAR≥22 is satisfied and a polar code is used, a total CRC length may satisfy LCRC=LFAR+3. This may be to comply with a CRC generating rule that is applied according to a payload of control data.

Option 1-2-m: In the case where a HARQ-ACK payload is L and a CRC length satisfying a FAR target is LFAR, if L+LFAR<22 is satisfied, a total CRC length may satisfy LCRC=LFAR+3 and may include 3-bit parity bits. If L+LFAR≥22 is satisfied and a polar code is used, a total CRC length may satisfy LCRC=LFAR+3. This may be used when Option 1-2-k is used. In this case, a CRC structure may be determined on the basis of Lmax defined in Option 1-2-k. In this case, a value of Lmax may be determined according to a condition of Lmax-3<22. This may be to reduce decoding complexity that is likely to happen when there is a plurality of candidate cannel coding schemes to be decoded by the base station.

Option 1-2-n: In the case where a CRC length satisfying a FAR target is LFAR, if a polar code is used, a total CRC length may satisfy LCRC=LFAR+3. In this case, a parity check bit is not used. This may be used when the Option 1-2-k is used, and, in this case, a CRC structure may be determined on the basis of Lmax defined in Option 1-2-k. In this case, a value of Lmax may be determined under a condition of Lmax-3≥22. This may be to reduce decoding complexity by simplifying a CRC structure to be decoded by the base station.

A method for determining a generation rule and a position when a distributed CRC is used in Option 1-2-1, Option 1-2-m, and Option 1-2-n, and a method for determining a generation rule and a position when a parity check bit is used may be determined according to a HARQ-ACK payload to be used for actual transmission. In this case, the method for determining a position of a distributed CRC and/or a parity check bit may be a method for determining an interleaving pattern to be applied after CRC and/or a parity check bit is attached to data.

In this case, if a HARQ-ACK payload estimated through counter DAI is L and a threshold used to determine the HARQ-ACK payload is Tpayload, the HARQ-ACK payload used for actual transmission may be set to be Lmax=max(L, Tpayload).

In the case where an encoder size is determined using the predetermined information A defined in the Proposal 1-2) and in the case where a polar code is used in a control channel of NR, a polar code encoder size may be determined on the basis of a sum of a HARQ-ACK payload size and a CRC length.

In this case, a criterion of determining a polar code encoder size, a threshold TE_size may be applied with respect to the sum of the HARQ-ACK payload size and the CRC length.

As a specific example, in the case where it is assumed that a HARQ-ACK payload is L and that a CRC length is LCRC, an encoder having a size of Nrep=2n may be applied if L+LCRC<TE_size is satisfied, and, an encoder having a size of Npunc=2n+1 may be applied if L+LCRC≥TE_size is satisfied. In this case, a bit size M capable of being mapped onto an uplink physical channel for transmission may satisfy a condition of 2n<M<2n+1.

In the case where modulation is determined using the predetermined information A defined in the Proposal 1-2, if the HARQ-ACK payload in a control channel of NR is less than a predetermined threshold LThr, BPSK (or π/2-BPSK) may be used, and, if the HARQ-ACK payload is equal to or greater than the predetermined threshold LThr, QPSK may be used.

In the Proposal 1-2, if the HARQ-ACK is transmitted along with other uplink channel information (e.g., CSI report, SR, and the like), the above operation described on the basis of the HARQ-ACK payload may be set to be performed on the basis of a sum of the HARQ-ACK payload and other uplink channel information payload.

In this case, if a channel coding scheme whose reliability depends on an encoder input bit index such as a polar code or an RM code is used, other control information may be set to be located at more reliable positions than information on HARQ-ACK. This may be other control information to be equally interpreted even when the HARQ-ACK payload is miss-matched.

When the base station provides the terminal with information related to HARQ-ACK through DCI, the information may include only counter DAI without DAI. This may be to prevent an increase of DCI overhead caused by provision of the total DAI. At this point, the terminal may not accurately recognize a total HARQ-ACK payload intended by the base station. In this case, the terminal may determine the size of the HARQ-ACK payload size on the basis of a specific fixed value which is predetermined, on the basis of a fixed value which is determined through a specific signal or DCI, or on the basis of a fixed value that can be used when a specific condition is satisfied. Alternatively, the following option 1-3) suggests a method that is applicable in such a situation.

1-3 Proposal 1-3: The Predetermined Information A May be a HARQ-ACK Payload Size.

When only counter DAI except total DAI is given through DCI, a HARQ-ACK payload size may be determined on the basis of a fixed value.

If the fixed value is L in the Proposal 1-3, the HARQ-ACK payload size may be L.

A position at which each HARQ-ACK bit is mapped in a HARQ-ACK payload may be determined through counter DAI included in DCI corresponding to a corresponding HARQ-ACK bit.

In the case where a maximum value of counter DAI detected by the terminal is Lcounter, if DCI including particular counter DAI having an index less than Lcounter is missing, a HARQ-ACK bit corresponding to the missing DCI may be set to follow the expression of NACK.

In the case where a maximum value of DAI detected by the terminal is Lcounter, if L>Lcounter is satisfied, a method for processing a HARQ-ACK bit having an index greater than Lcounter may be one of the following options.

Option 1-3-A-1: Corresponding HARQ-ACK bits may be processed into frozen bits. In this case, a rule (e.g., scrambling) applied to other frozen bits may be equally applied to the corresponding bits. This has an advantage of processing missing bits without additional information.

Option 1-3-A-2: Corresponding HARQ-ACK bits may be set to follow the expression of NACK. In this case, a rule (e.g., scrambling) applied to frozen bits is not applied to the corresponding bits. This may be to express information on a HARQ-ACK bit corresponding to missing DCI and to prevent the expression of NACK from being affected by a rule such as scrambling applied to a frozen bit.

In the Proposal 1-3, the fixed value may be one of the following options.

Option 1-3-B-1: The fixed value may be a value semi-statically set through SIB or a higher layer signal such as an RRC signal.

Option 1-3-B-2: The fixed value may be a value dynamically configured through DCI included in a PDCCH that is monitored by the terminal in order to obtain scheduling information.

Option 1-3-B-3: The fixed value may be a value (e.g., a wake up signal (WUS) or compact DCI) dynamically configured through a downlink physical channel (or signal) that is additionally configured by the terminal in order to set information regarding PDCCH reception or set a HARQ-ACK process.

Option 1-3-B-4: The fixed value may be a value determined according to a resource size (e.g., the number of RBs, the number of subcarriers, and/or the number of symbols) of an uplink physical channel used by the terminal to transmit HARQ-ACK and/or according to a HARQ-ACK configuring method (e.g., a PUCCH format).

In the case where a channel coding scheme is determined using the predetermined information A defined in the Proposal 1-3 and in the case where a HARQ-ACK payload in a control channel of NR is less than 12, an RM code may be used: in other cases, a polar code may be used.

When a CRC structure is determined using the predetermined information A defined in the Proposal 1-3,

A CRC length may be, for example, 0 when a HARQ-ACK payload in a control channel of NR is less than 12.

As another example, when the HARQ-ACK payload in a control channel of is less than 22 NR and a polar code is used as a channel coding scheme, a parity check bit may be used.

As yet another example, a position of a distributed CRC may be determined according to a HARQ-ACK payload size in a control channel of NR. This may be a method for determining an interleaving pattern to be applied after the CRC is attached to data.

In the case where an encoder size is determined using the predetermined information A defined in the Proposal 1-3 and in the case where a polar code is used in a control channel of NR, a polar code encoder size may be determined on the basis of a sum of a HARQ-ACK payload size and a CRC length.

In this case, as a criterion of determining the polar code encoder size, a threshold TE_size may be applied with respect to the sum between the HARQ-ACK payload size and the CRC length.

For example, in the case where a HARQ-ACK payload is defined as L and a CRC length is defined as LCRC, an encoder having a size of Nrep=2n may be applied if L+LCRC<TE_size is satisfied, and, an encoder having a size of Npunc=2n+1 may be applied if L+LCRC≥TE_size is satisfied. In this case, a bit size M capable of being mapped to an uplink physical channel for transmission may satisfy a condition of 2n<M<2n+1.

In the case where modulation is determined using the predetermined information A defined in the Proposal 1-3, if a HARQ-ACK payload in a control channel of NR is less than a predetermined threshold LThr, BPSK (or π/2-BPSK) may be used, and, if the HARQ-ACK payload is equal to or greater than the predetermined threshold LThr, QPSK may be used.

In the Proposal 1-2, when HARQ-ACK is transmitted along with other uplink channel information (e.g., CSI report, SR, and the like), the above-described operations described on the basis of a HARQ-ACK payload may be set to be performed on the basis of a total sum of the HARQ-ACK payload and other uplink channel information payload.

In this case, if a channel coding schemes whose reliability depends on an encoder input bit index such as a polar code or an RM code is used, other control information may be allocated at more reliable positions than information on HARQ-ACK.

This may be for other control information to be equally interpreted even when the HARQ-ACK payload is miss-matched.

In the case of a distributed CRC structure, a data bit affecting calculation of a CRC check of each CRC block may differ.

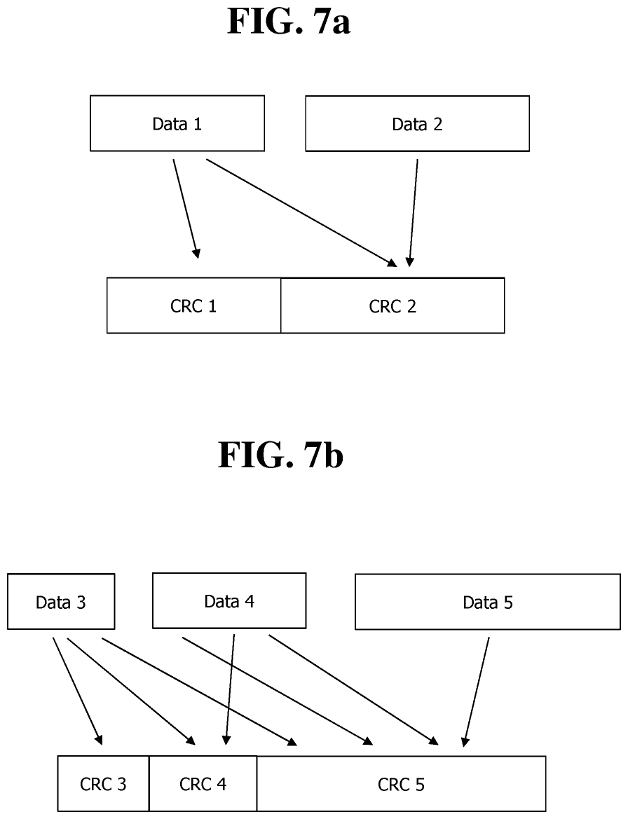

FIGS. 7A and 7B are diagram illustrating examples of a correlation between each distributed CRC block and each distributed data block when a distributed CRC structure is applied.

As illustrated, some CRC blocks may be designed to be affected only by some data blocks, and other CRC blocks may be designed to be affected by the whole data blocks. A method proposed in the present specification may include a method in which the above-described structure is used to map uplink channel information to data blocks that can be differentiated according to a distributed CRC structure according to each purpose. The following Proposal 2 suggests a method that is applicable in such a situation.

2. Proposal 2.

According to Proposal 2, when uplink channel information differentiated into a plurality of different purposes go through a single encoding process to apply channel coding, selecting a codeword to be applied to each uplink channel information may be determined according to a purpose of a corresponding uplink channel information and a CRC structure.

In the Proposal 2, the channel coding may be specifically a polar code.

In the Proposal 2, the codeword may refer to a position at which a data bit is located at an input stage of a polar code encoder.

In the Proposal 2, the uplink channel information may be differentiated in terms of purpose such as information for representing HARQ-ACK, information for SR, and/or information for CSI reporting, and the like.

In the Proposal 2, the CRC structure may include a CRC length.

In the Proposal 2, a distributed CRC structure may include a codewor (codeword) corresponding to each distributed CRC block, and a scheme of constructing a codeword of a data block associated with each distributed CRC block.

In this case, a codeword of a data block associated with a CRC block may refer to codewords corresponding to data blocks included in a CRC check calculating procedure of each CRC block.

FIG. 7A illustrates an example of a correlation between each data block and each CRC block when uplink channel information is differentiated into two CRC blocks and two data blocks.

FIG. 7B illustrates an example of a correlation between each data block and each CRC block when uplink channel information is differentiated into three CRC blocks and three data block.

In the Proposal 2, when uplink channel information for different purposes includes HARQ-ACK and CSI report and is capable of being divided into two data blocks and two control blocks, as shown in the structure of FIG. 7A, it is possible to map information of HARQ-ACK to a region of Data 1 and CSI report to a region of Data 2.

In the Proposal 2, when uplink channel information for different purposes includes HARQ-ACK, SR, and CSI report and is capable of being divided into two data blocks and two control blocks, as shown in the structure of FIG. 7A, it is possible to map information of HARQ-ACK and SR to a region of Data 1 and CSI feedback information to a region of Data 2.

In the Proposal 2, when uplink channel information for different purposes includes HARQ-ACK responsive to a PDSCH received from two different cells and is capable of being divided into two data blocks and two control blocks, as shown in the structure of FIG. 7A, it is possible to map HARQ-ACK information of a primary-cell or lower-cell index to a region of Data 1 and HARQ-ACK information of a secondary-cell or higher cell index to a region of Data 2.

In the Proposal 2, when uplink channel information for different purposes includes HARQ-ACK and CSI report responsive to a PDSCH received from two different cells and is capable of being divided into three data blocks and three control blocks, as shown in the structure of FIG. 7B, it is possible to map HARQ-ACK information of a primary-cell or lower-cell index to a region of Data 3, HARQ-ACK information of a secondary-cell or higher cell index to a region of Data 4, and CSI report information to a region of Data 5

The Proposal 2 may be used in combination with the Proposal 1.

The embodiments of the present specification may be achieved by various means. For example, the embodiments of the present specification may be achieved by hardware, firmware, software, or a combination thereof. A detailed description thereof will be provided with reference to the accompanying drawings.

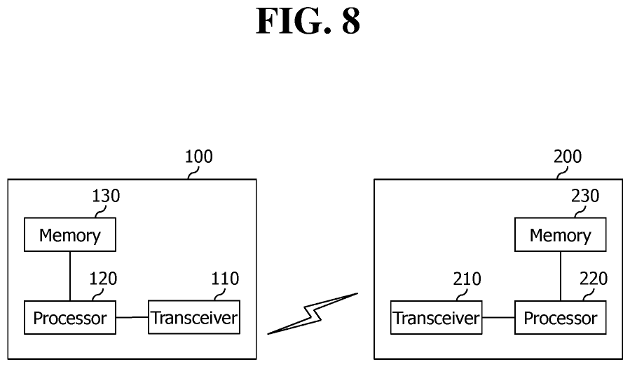

FIG. 8 is a block diagram of a wireless communication system implementing a disclosure of the present specification.

A base station 200 may include a processor 201, a memory 202, a transceiver (or a radio frequency (RF) unit) 203. The memory 202 may be connected with the processor 201 to store various types of information for driving the processor 201. The transceiver (or the RF unit) 203 may be connected with the processor 201 to transmit and/or receive a radio signal. The processor 201 may implement the proposed functions, procedures, and/or methods. In the above embodiments, operations of the base station may be implemented by the processor 201.

A wireless device (e.g., an NB-IoT device) 100 may include a processor 101, a memory 102, and a transceiver (or a radio frequency (RF) unit) 103. The memory 102 may be connected with the processor 101 to store various types of information for driving the processor 101. The transceiver (or the RF unit) 103 may be connected with the processor 101 to transmit and/or receive a radio signal. The processor 201 may implement the proposed functions, procedures, and/or methods.

A processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present specification is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present specification.

What is claimed is:

1. A method performed by a user equipment (UE) to transmit hybrid automatic repeat request (HARQ) positive-acknowledgement (ACK)/negative-acknowledgement (NACK) information, the method comprising:
determining, based on first information, a channel coding scheme to be used to transmit the HARQ ACK/NACK information through an uplink physical channel; and
performing channel coding on the HARQ ACK/NACK information according to the determined channel coding scheme,
wherein the channel coding scheme comprises at least one of a channel coding scheme, a cyclical redundancy check (CRC) architecture, a channel encoder size, and a modulation scheme.

2. The method of claim 1, further comprising:
receiving downlink control information (DCI) through a downlink control channel; and
receiving, based on the DCI, downlink data through a downlink data channel,
wherein the HARQ ACK/NACK information is associated with the downlink data.

3. The method of claim 2, wherein the first information comprises a payload size of the HARQ ACK/NACK information.

4. The method of claim 3, wherein, when total downlink assignment index (DAI) is included in the DCI, the payload size of the HARQ ACK/NACK information is determined on the basis of the total DAI.

5. The method of claim 3, wherein, when only counter DAI except total DAI is included in the DCI, the payload size of the HARQ ACK/NACK information is determined on the basis of a fixed value.

6. The method of claim 3, wherein when only counter DAI except total DAI is included in the DCI, the payload size of the HARQ ACK/NACK information is determined on the basis of a maximum value of a detected counter DAI.

7. The method of claim 6, wherein the maximum value of the detected counter DAI is Lcounter, the payload size of the HARQ ACK/NACK information is determined on the basis of a smallest values among values greater than Lcounter+x in a candidate set Z={L1, L2, . . . , LM}.

8. The method of claim 1, wherein the CRC structure comprises a CRC length, a distributed CRC type, a multiple CRC type, and a parity check bit.

9. A user equipment (UE) for transmitting hybrid automatic repeat request (HARQ) positive-acknowledgement (ACK)/negative-acknowledgement (NACK) information, the UE comprising:
a transceiver; and
a processor configured to control the transceiver,
wherein the processor is further configured to:
determine, based on first information, a channel coding scheme to be used to transmit the HARQ ACK/NACK information through an uplink physical channel; and
perform channel coding on the HARQ ACK/NACK information according to the determined channel coding scheme, and
wherein the channel coding scheme comprises at least one of a channel coding scheme, a cyclical redundancy check (CRC) architecture, a channel encoder size, and a modulation scheme.

10. The UE of claim 9,
wherein the processor is further configured to control the transceiver so as to perform operations comprising;
receiving downlink control information (DCI) through a downlink control channel;
receiving, based on the DCI, downlink data through a downlink data channel, and
wherein the HARQ ACK/NACK information is associated with the downlink data.

11. The UE of claim 10, wherein the first information comprises a payload size of the HARQ ACK/NACK information.

12. The UE of claim 11, wherein, when total downlink assignment index (DAI) is included in the DCI, the payload size of the HARQ ACK/NACK information is determined on the basis of the total DAI.

13. The UE of claim 12, wherein the maximum value of the detected counter DAI is Lcounter, the payload size of the HARQ ACK/NACK information is determined on the basis of a smallest values among values greater than Lcounter+x in a candidate set Z={L1, L2, . . . , LM}.
